(19) United States
(12) Patent Application Publication
(10) Pub. No.: US 2015/0248213 A1
(43) Pub. Date: Sep. 3, 2015

(54) METHOD TO ENABLE HARD KEYS OF A DEVICE FROM THE SCREEN

(71) Applicant: SAMSUNG ELECTRÔNICA DA AMAZÔNIA LTDA., MANAUS - AM (BR)

(72) Inventor: Antonio Henrique Barbosa POSTAL, Sao Paulo (BR)

(73) Assignee: SAMSUNG ELECTRÔNICA DA AMAZÔNIA LTDA., MANAUS - AM (BR)

(21) Appl. No.: 14/253,323

(22) Filed: Apr. 15, 2014

(30) Foreign Application Priority Data
Feb. 28, 2014 (BR) 1020140050418

(51) Int. Cl. G06F 3/0481; G06F 3/0484; G06F 3/0482; G06F 3/0354; G06F 3/041

(52) U.S. Cl. CPC G06F 3/04817; G06F 3/03547; G06F 3/041; G06F 3/0482; G06F 3/04847; G06F 2203/04101

(57) ABSTRACT

A method to allow a user, in a replacement or alternate way, to activate functions of hard keys on a device with a touch-sensitive display screen without the user touch or press the hard key, using only the device screen and a pointer device. In particular, the method executed by an exemplary system is accomplished by following the operations of accessibility, empowerment and activation of hard function keys to make accessible to the user, an icon or visual notification on a predefined display area previously mapped to that key, enable the icon during a predefined time interval when the user positions briefly a pointer device on the predefined area and activate the function of the hard key to slide the icon in a sense that the hard key would be pressed.

### CROSS-REFERENCE TO RELATED APPLICATIONS

This application claims the benefit of Brazilian Application No. BR 10 2014 005041 8, filed Feb. 28, 2014, in the Brazilian Intellectual Property Office, the disclosure of which is incorporated herein by reference.

### BACKGROUND

1. Field

The following description relates to a method which makes optional or eliminates the need for hard keys on a device with a touch screen. In particular, the method relates to a set of instructions followed by a mobile device with a touch screen that show the hard keys functions for a given time interval to the user when a pointer is positioned over a bounded display area along the edge of the screen.

2. Description of the Related Art

Portable communication devices that are increasingly lightweight and handy are sought after by consumers, making it desirable to eliminate the need of hard keys in order to reduce the weight and complexity of the handling of these mobile devices. In this case, some techniques to enhance the utility of available space on the touch screen, such as accessing hidden edge menus to perform actions depending on context, and exploring the features of the touch surfaces of the devices are employed in the art. The implementations for assigning functions to the hidden keys devices with a touch screen are explored in the art. Several implementations of keys use a grid of keys arranged in a menu.

The document EP 2573667 A2, entitled: “Overlays for Touch Screens Sensitive Buttons to Simulate or Other Tactually or Visually Discernible Areas”, published on Mar. 27, 2013, shows an overlay to be implemented on a device with a touch screen that visually or by touch simulates a button or screen area and a method for generating an active region, detecting touch on a particular area of overlap corresponding to the active region, and generating a signal indicating that the active region was activated. However, unlike the present disclosure, the method does not mention that the functions to be generated by the active region are the functions of the buttons located outside the display area of the device.

The document EP 2474890 A1 entitled: “Virtual Keyboard Configuration putting fingers in rest positions on a multi-touch screen, calibrating key positions thereof”, published on Jul. 11, 2012, discloses a device and method for identifying which fingers touch predetermined areas of one touch-sensitive surface based on the touched area of the screen area. In one embodiment, the surface is used as a touchpad that is activated by sliding a finger on the surface. Further, if the surface is not touched during a time interval, the group corresponding to that finger is disregarded. However, the functionality of physical buttons assigned to predetermined areas of the touch screen is not mentioned in this document.

The patent document U.S. 2013/181902 entitled: “Skinnable Touch Device Grip Patterns”, posted on Jul. 25, 2013 requires that the surface of the device is also touch sensitive. The touch-sensitive surface contains a plurality of sensors that indicate how the user is holding the device, allowing the creation of standards that fit the way the device is being handled. However, the present disclosure maps external functions to be accessed within the area of display screen without the need of other touch surfaces on the device.

The patent document U.S. 2012/233570 A1 entitled: “Border Menu for Context Dependent Actions Within a Graphical User Interface”, published on Sep. 13, 2012, discloses a method to present to the user dependent actions of a context within a user interface comprising an edge menu associated with each of the four edges containing user-selectable options through a pointer. These selectable options trigger events that execute programmable codes according to a selected option of application's list of the device. The present disclosure differs by mapping selectable options within the display screen to be executed within the user interface and the present disclosure maps any edge point outside the device's display screen and enables the functions of hard keys by adding graphical objects that can be activated within the display screen.

The patent document WO 2008155010 A1 entitled: “Mobile Device with Touch Input Surface”, posted on Dec. 24, 2008, describes a mobile device having a touch-sensitive outer surface in which a method and system are set to collect the touch information received by the external surface and determine which finger the user used for typing. In the present disclosure, the functionality of the touch screen is used to bring the functions of hard keys that are directly inaccessible on the display screen so that they can be performed on the screen by the user.

The SwipePad Android application has an approach similar to the principles of accessibility, empowerment, and activation employed in the present disclosure. The Swipe Pad allows the user to have access to a grid on the edge of the display screen where there are predefined shortcuts of Android applications and services. In contrast, the present disclosure uses a pointer device to uniformly access the functions on the touch screen including the functions of external keys without the need to switch between the use of a pointer device and the finger to select these functions.

### SUMMARY

Additional aspects and/or advantages will be set forth in part in the description which follows and, in part, will be apparent from the description, or may be learned by practice of the invention.

The present disclosure aims to activate the functions of physical buttons on the touch screen of the device, requiring the user to press these hard keys. Some examples of hard keys are buttons, radio buttons, and switches located outside the area of the device's screen.

The method to activate the functions of hard keys through a screen interface sensible to touch or pointer device may include the following operations:
providing accessibility to a delimited area of the display by detecting the pause action of a pointer device over the predefined display area bounded near the edge of the device screen and originally mapped to perform functions of hard keys;
enable the functions of the hard keys exposing the user to an icon or visual notification after detecting the pause action of the pointer device over the predefined display area bounded for a predefined time interval;
activate the functions of hard keys by sliding the enabled icon in a sense that the hard key would be pressed within a predetermined time after the operation of enabling the functions of hard keys.

The method of the present disclosure provides benefits to the user as a more comfortable experience in accessibility, because the user can activate the functions of physical buttons on the GUI display screen and a more uniform interface by using the method and pointer device to access all functions of the device, regardless of whether they were designed to be performed from the touch sensitive display or the hard keys. Another aspect to be noted in the increased accessibility is the fact that people with disabilities have easy access to hard keys, because the device can be a pointer Stylus pen, for example.

Another great benefit of this disclosure is the possibility of remote access to the physical buttons of the device through screen sharing software. For example, a cell phone with a shared screen allows the user to perform predetermined activities and to remotely test the device.

The hard keys often have different functions depending on the application context. For example, the side smart key in the context of Desktop (or Home) application serves to lock the screen, in Alarm context has function of silencing the alarm, and in the context of call application must end a call. According to an embodiment of the disclosure, to allow viewing of different icons for the same hard key role in the multi-operation enablement, the user has the facility to know the exact function of this key within the context before its activation.

The benefits to be achieved in view of the manufacturers are cutting costs by reducing or eliminating the use of hard keys, thus simplifying the production and differentiation, given that the new models can use the physical space of the buttons for other details or new formats that may be more streamlined and clean.

### BRIEF DESCRIPTION OF THE DRAWINGS

The objectives and advantages of the invention will become apparent from the following detailed description of an exemplary and non-limiting embodiment from the following figures, wherein:

FIG. 1 shows an exemplary system in which the user uses pointer to access and activate a hard side key.

FIG. 2 shows an exemplary system in which the user uses pointer to access, enable and activate a hard key on the display screen.

FIG. 3 shows a plurality of examples of mapping between hard keys and icons for activating the functions of these hard keys occurs.

FIG. 4 shows the sequence of operation of the method of the present disclosure over the time, with the interaction that occurs between the user, the screen of the device and the application running.

### DETAILED DESCRIPTION

Reference will now be made in detail to the embodiments, examples of which are illustrated in the accompanying drawings, wherein like reference numerals refer to like elements throughout. The embodiments are described below to explain the present invention by referring to the figures.

Initially, it is noteworthy that, for the selection of the functions of the physical buttons on the device screen, according to an embodiment of the disclosure, one should choose a pointer device. In the case of the examples shown in the figures, a Stylus Pen was used as a pointer device, and the same idea applies to a mouse, a touchpad, a remote control Smart TV, but the disclosure is not limited to these examples.

The following describes embodiments of the method to activate a hard key from the touchscreen or pointer device.

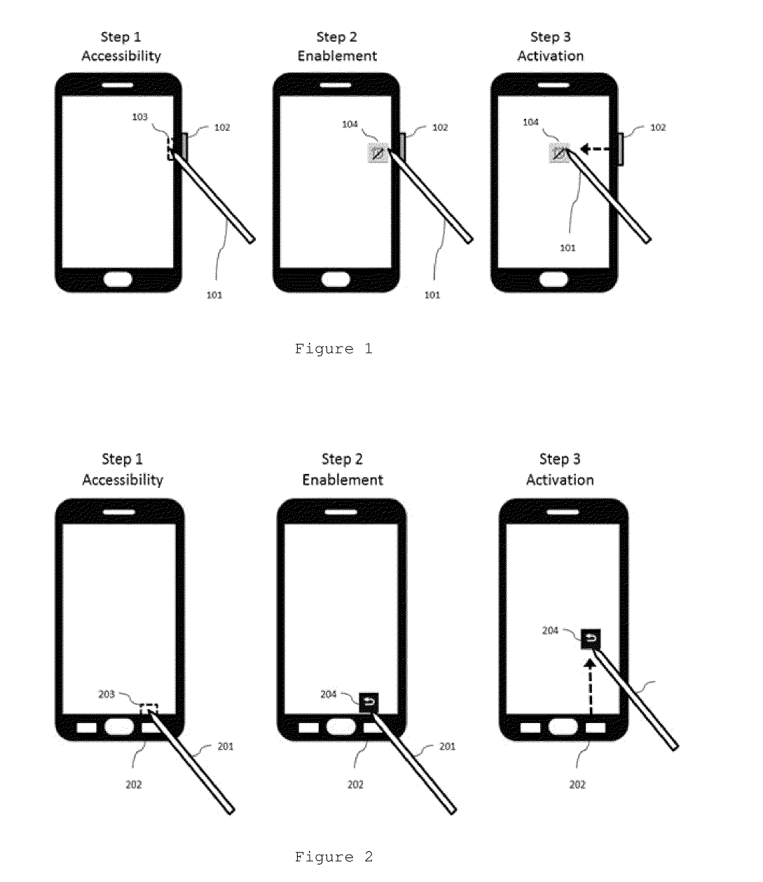

In FIG. 1, an exemplary system is shown to activate the hard keys from a mobile device equipped with a smart key 102 external to the display screen. A smart key allows the user to assign any function of the device to it. For example, the user can choose to start the clock, calendar, calculator, or other function just by clicking on the smart key. Therefore, its interface may vary with the context of the current application. The user uses a pointer 101 to access and activate the function he wants the mobile device to perform. In a first operation, the user may momentarily rest the pointer device 101 over an area 103 previously bounded on the screen edge next to the actual location of the smart key 102. The smart key 102 in accordance with an embodiment of the disclosure is positioned on the side of the device. However, those skilled in the art will appreciate that other configurations are admissible depending on the model and manufacturer of the apparatus. The momentary pause of the pointer device 101 on this area 103 previously defined must be done so that access to hard key function is enabled.

The second operation occurs after the detection of action momentary pause of the pointer device 101 on the area 103 previously defined. The function of the hard key is displayed to the user as an icon 104 or other visual representation on the tip of the pointer device. The user has the option to activate the function of the hard key or not once it has been enabled in the GUI. If the user chooses not to activate the hard key, the method is canceled, the icon 104 function smart key 102 is deleted and the area 103 previously defined returns to the state of affordability. The icon 104 is disregarded if: a defined time interval occurs without any user action to activate the feature enabled, the user's focus away the enabled icon 104 or click on another button containing other defined function.

To perform the third operation, the user clicks the icon 104 is enabled and represents the function of smart key and slide the pointer device 101 in the direction in which the button would be pressed manually in a predetermined time interval. For example, in FIG. 1 the smart key 102 is positioned on the right side of the device. So when a user presses the smart key 102, the sense would be from right to left. The sense that the user must slide the icon 104 with the pointer device 101 to turn it on is from right to left. The icon 104 remains enabled for a predetermined time interval.

FIG. 2 shows another implementation that makes use of the present method to activate a physical button positioned on the frontal portion of a device. The same approach as described for FIG. 1 is used, changing only the arrangement of the hard key.

In a first operation, a pointer device 201 is positioned briefly over an area 203 previously defined that defines a hard key function of a physical button on the frontal portion of the device. The area 203 can be predefined in any region of the graphical interface of the touch sensitive display screen. In the implementation shown in FIG. 2, the area 203 is previously set near the lower display edge of a hard key “Back” 202 of the device.

In a second operation, an icon 204 is displayed at the tip of the pointer device 201 in the graphical interface of the touch screen for a predetermined time interval in order to notify that the function of the hard key “Back” 202 is enabled. If the user focus away from the icon, click on another button containing other defined function or do not click on the icon 204 for a predetermined time interval, the icon is dropped and the method canceled.

In a third operation, the user positions the pointer device 201 on the icon 204 enabled and click sliding it in the sense that the physical button would be pressed within a predetermined time interval. In the case of hard key “Back” 202 at the bottom of the touch screen, the sense that the user slides the icon 204 with the pointer device 201 is upwards.

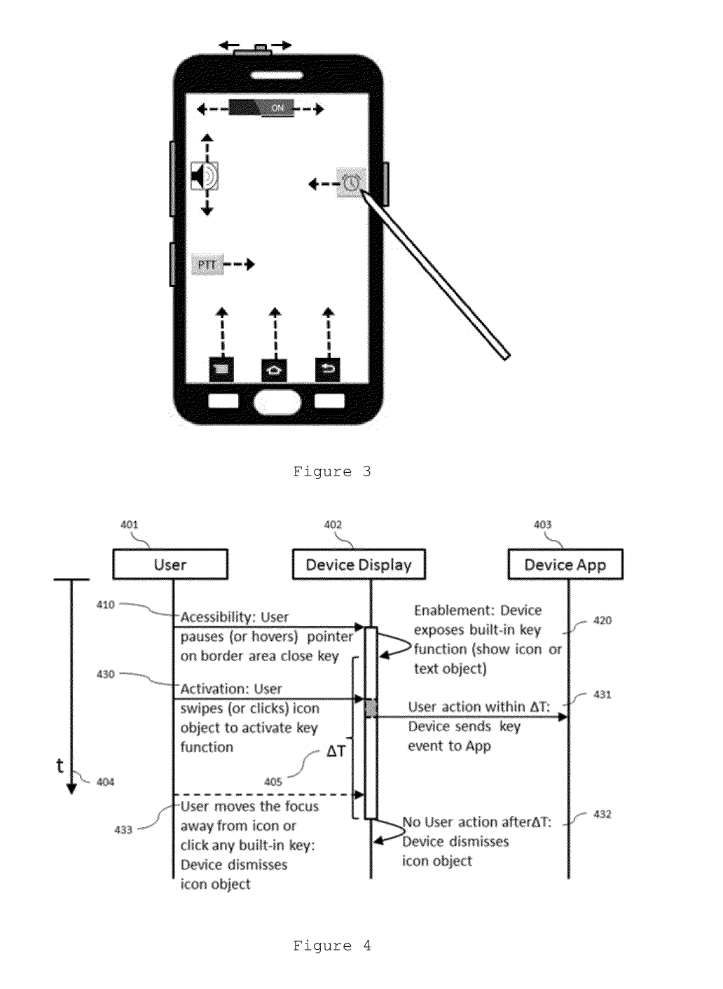

In FIG. 3 is shown a mapping that can be applied to an embodiment of the disclosure of physical buttons, icons and the sense the icons must be slide to activate the functions of physical buttons. A “Power” button positioned on the top edge of the device turns the device on when the key is positioned to the right and turns it off when it is on the left side. Therefore, the function corresponding to the physical button “Connect” icon would be enabled for a predetermined time interval at the upper edge of the graphical interface of the touch screen, next to the actual hard key. If shifted to the right, the icon activates the “Connect” function of the device and if it is shifted to the left, deactivates the device.

In a similar way, a “Volume” button is located on the left side of a device containing two buttons, one higher to increase the volume and lower to decrease the volume. The function corresponding to the hard key “Volume” icon is enabled on the left side of the device near the edge of the “Volume” button. Once positioned the pointer device over the icon of the function “Volume” and clicked, the slip -up causes the device volume increased and the case slid down, causes the volume decreased. The “Menu”, “Home” and “Back” buttons at the bottom of the device's display screen would have their icons positioned on the bottom of the graphical interface of the device, near their respective hard keys. The sense of activation functions defined hard key on these icons would be upwards. Another button located on the left side of the device would be the “PTT” button that is pushed from left to right by the user's finger. The icon corresponding to your physical function is positioned at the left edge of the touch screen GUI, preferably near physical touch “PTT”. Unlike the “Volume” button, the “PTT” button performs one action, and then the default sense would be from the left to the right.

FIG. 4 shows a sequence diagram representing the operations of the method to activate hard keys from the touch screen of a device along a time axis 404. In it are defined three actors that are a user 401, a display device 402, and a device application 403. The interaction between the user and the method starts from the moment that accessibility 410 is established, i.e. a pause momentarily pointer device is detected on an edge area of the touch screen with a predetermined hard key function. After accessibility 410 is established, the device will enable icon 420 that comprises the function of that hard key for a specified time interval 405. The activation operation 430 to the hard key 401 occurs when the user clicks the icon or slips in that the hard key was pressed within a predefined time interval 405. If the user 401 acts in the time interval 405, the display device 402 sends the event of hard key 431 to the application of the device 403. If the user 401 departs the focus away from the icon or click on another button with another function set 433, the icon is dropped and the method terminates 432. If no user action occurs during the time interval 405, the icon is dropped and the method terminates.

Although the present disclosure has been described in connection with embodiments, it should be understood that it is not intended to limit the disclosure to those particular embodiments. Rather, it is intended to cover all alternatives, modifications and equivalents possible within the spirit and scope of the invention as defined by the appended claims.

What is claimed is:

1. A method for activating a function of a hard key on a Graphical User Interface (GUI) screen, in a system with a device with a touchscreen, a hard key, and a pointer device, the method comprising:
providing accessibility to a display area bounded to detect a momentary pause action of a pointer device on a predefined bounded area of the display area near an edge of the screen of the device previously mapped to perform a function of the hard key;
enabling a function of the hard key exposing to a user an icon after detecting the pause action of the pointer device on the bounded display area; and
activating the function of the hard key to slide the icon in a sense that the hard key would be pressed for a predetermined period of time after enabling the function of the hard button.

2. The method of claim 1, wherein the providing accessibility to the bounded display area is performed by a proximity sensor.

3. The method of claim 1, wherein the icon is automatically removed from the screen if no user action occurs in the predetermined time period.

4. The method of claim 1, wherein the activation of the hard key function is performed by clicking on the icon in the predetermined period of time.

5. The method of claim 1, wherein the hard key, icon, and the sense which the icon must be slid to activate the function of the hard key are mapped.
